(19) United States
(12) Patent Application Publication
(10) Pub. No.: US 2007/0008481 A1
(43) Pub. Date: Jan. 11, 2007

(54) Fabrication process of liquid crystal display apparatus

(75) Inventor: Shota Makimoto, Kawasaki-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/441,064

(22) Filed: May 26, 2006

(30) Foreign Application Priority Data
May 30, 2005 (JP) 2005-157584

(51) Int. Cl. G02F 1/13

(52) U.S. Cl. 349/187

(57) ABSTRACT

A method of fabricating a liquid crystal display apparatus having a liquid crystal layer sandwiched between a first substrate and a second substrate comprises the steps of forming the liquid crystal layer by dripping a liquid crystal composition containing a photopolymerizable component upon the first substrate, and sandwiching the liquid crystal layer between the first and second substrates by mounting the second substrate upon the first substrate, wherein the dripping step of the liquid crystal composition is conducted in a state in which the liquid crystal composition is shielded from a radiation of a wavelength that causes polymerization in the photopolymerizable component.

### BACKGROUND OF THE INVENTION

The present invention generally relates to display apparatuses and more particularly to a fabrication process of a liquid crystal display apparatus of vertical alignment mode and production apparatus therefor.

FIGS. 1A and 1B show the principle of a vertical alignment liquid crystal display apparatus 10 called also an MVA apparatus according to the inventor of the present invention, wherein FIG. 1A shows the liquid crystal display apparatus 10 in a non-activated state in which no drive voltage is applied thereto, while FIG. 1B shows the liquid crystal display apparatus 10 in a drive state in which a drive voltage is applied.

Referring to FIG. 1A, a liquid crystal layer is sandwiched between glass substrates 11A and 11B, and the glass substrates 11A and 11B constitute, together with the liquid crystal layer 12, a liquid crystal panel.

The glass substrates 11A and 11B are formed with respective alignment films not illustrated, wherein the alignment films cause alignment of liquid crystal molecules in the liquid crystal layer 12 in the direction generally perpendicular to the liquid crystal layer 12 in the non-activated state of FIG. 1A.

Thus, in the state of FIG. 1A, the optical beam incident to the liquid crystal display apparatus undergoes no substantial rotation of polarization plane as it travels through the liquid crystal layer 12, and thus, the optical beam incident to the liquid crystal layer 12 through a polarizer disposed underneath the liquid crystal panel is shutoff by an analyzer disposed above the liquid crystal panel with the construction in which the analyzer and the polarizer are disposed above and below the liquid crystal panel in a crossed Nicol state.

In the driving state of FIG. 1B, on the other hand, the liquid crystal molecules are tilted in the liquid crystal layer 12 as a result of the electric field applied to the liquid crystal layer 12, and there is induced a rotation of polarization plane in the optical beam incident to the liquid crystal layer 12. As a result, the optical beam passed through the polarizer and incident to the liquid crystal layer 12 can pass through the analyzer without being shutoff.

Further, with the liquid crystal display apparatus 10 of FIGS. 1A and 1B, there are formed. projecting patterns 13A and 13B respectively on the glass substrates 11A and 11B so as to extend parallel with each other, wherein the projecting patterns 13A and 13B are provided for restricting the direction in which the liquid crystal molecules are tilted at the time of transition from the non-activated state to the activated state of the liquid crystal display apparatus 10, in the prospect of improving the response speed at the time of the transition.

By forming such projecting patterns 13A and 13B, the response speed of the liquid crystal display apparatus 10 is improved, and at the same time, the viewing angle characteristics of the liquid crystal display apparatus are improved significantly as a result of formation of plural domains with respective, different tilting direction for the liquid crystal molecules in the liquid crystal layer 12.

### REFERENCES

| | |
|---|---|
| PATENT REFERENCE 1 | United States Patent |
| | Publication 2002/0159018 |
| PATENT REFERENCE 2 | United States Patent |
| | Publication 2003/0048401 |
| PATENT REFERENCE 3 | United States Patent |
| | Publication 2005/0088582 |
| PATENT REFERENCE 4 | United Sates Patent 6977794 |
| PATENT REFERENCE 3 | United States Patent |
| | Publication 2005/0146664 |

### SUMMARY OF THE INVENTION

FIG. 2 shows a schematic construction of an active-matrix liquid crystal display apparatus 30 based on the construction of FIGS. 1A and 1B.

Referring to FIG. 2, the liquid crystal display apparatus 30 includes a TFT glass substrate 31A carrying thereon a large number of thin-film transistors (TFTs) together with transparent pixel electrodes cooperating with the respective, corresponding TFTs. Further, an opposing glass substrate 31B is provided over the TFT substrate 31A so as to carry thereon an opposing electrode, wherein a liquid crystal layer 31 is confined between the substrates 31A and 31B by a seal member 31C.

With the liquid crystal display apparatus 30 of FIG. 2, a TFT corresponding to a selected pixel electrode is activated, and the alignment of the liquid crystal molecules in the liquid crystal layer 31 is changed selectively in correspondence to the selected pixel electrode.

Further, a polarizer 31a and an analyzer 31b are disposed at respective outer sides of the glass substrates 31A and 31B in a crossed Nicol state.

Further, alignment films not illustrated are formed at respective inner sides of the glass substrates 31A and 31B in contact with the liquid crystal layer 31, and the alignment direction of the liquid crystal molecules is restricted generally perpendicular to the plane of the liquid crystal layer 31 in the non-activated state of the liquid crystal display apparatus.

For the liquid crystal layer 31, it is possible to use a liquid crystal having a negative dielectric anisotropy marketed by Merck KGaA, while it is possible to use a vertical alignment film provided by JSR Corporation for the alignment film. In a typical example, the substrates 31A and 31B are assembled by using a suitable spacer such that the thickness of the liquid crystal layer becomes about 4 μm.

FIG. 3A shows the liquid crystal display apparatus 30 of FIG. 2 in a cross-sectional view, while FIG. 3B shows a part of the TFT glass substrate 31A in an enlarged scale.

Referring to FIG. 3A, there is formed a pixel electrode 34 in electrical connection to a TFT 31T not illustrated in FIG. 3A, and the pixel electrode 34 is covered by an orientation film 35. Similarly, there is formed an opposing electrode 36 on the upper glass substrate 31B uniformly, wherein the opposing electrode 36 is covered by another vertical alignment film 37. Further, the liquid crystal layer 22 is sandwiched between the substrates 31A and 31B in a state contacting with the alignment films 35 and 37.

Referring now to FIG. 3B, there are formed a large number of pad electrodes 33A on the glass substrate 31A for receiving scanning signals, and a large number of scanning electrodes 33 are formed so as to extend over the glass substrate 31A from respective pad electrodes 33A. Further, there are formed a large number of pad electrodes 32A on the glass substrate 31A for receiving image signals, and a large number of signal electrodes 32 are formed so as to extend over the glass substrate 31A in a direction generally perpendicular to an extending direction of the scanning electrodes 33. Further, TFTs 31T are formed at the intersections of the scanning electrodes 33 and the signal electrodes 32.

On the substrate 31A, there are formed transparent pixel electrodes 34 in correspondence to the TFTs 31T, wherein each TFT 31T is selected by a scanning signal on a corresponding scanning electrode 33 and drives a corresponding transparent electrode 34 of ITO, or the like, by the video signal supplied to a corresponding signal electrode 32.

In the non-activated state of the liquid crystal display apparatus 30, there is no drive voltage applied to the transparent pixel electrode and the liquid crystal molecules are aligned generally perpendicularly to the plane of the liquid crystal layer 31. Thereby, the liquid crystal display apparatus 30 provides a black representation as a result of the polarizing action of the polarizer 31a and the analyzer 31b.

On the other hand, when a drive voltage is applied to the transparent pixel electrode 34 in correspondence to the activated state thereof, the liquid crystal molecules are aligned generally horizontally, and the liquid crystal display apparatus 30 provides a white representation in the pixel thus activated.

As shown in FIG. 3A, there is formed a projecting pattern 36 on the upper electrode 36 on the glass substrate 31B as a result of patterning of a resin such as a resist film. Thereby, the projecting pattern 36A causes tilting in the liquid crystal molecules similarly to the projecting pattern 13B of FIGS. 1A and 1B. Further, there are formed cutout patterns in the transparent electrode 34 wherein the cut out patterns thus formed in the transparent electrode 34 induce tilting of the liquid crystal molecules similarly to the projecting patterns 13A shown in FIGS. 1A and 1B by causing localized modulation of the electric field.

FIG. 4 shows the construction of a single pixel electrode 34 formed on the substrate 31A in detail.

Referring to FIG. 4, there extend a signal electrode 32 and a scanning electrode 33 over the glass substrate 31A in a crossing manner, and a TFT 31T and a corresponding pixel electrode 34 are formed in correspondence to the intersection of the electrodes 32 and 33. Further, it can be seen in FIG. 4 that there is formed an auxiliary electrode 34C (Cs) parallel to the scanning electrode 33.

In FIG. 4, the electrode 34 represented with mat pattern is divided into regions A-D, wherein each region is formed with minute cutout patterns 34A represented by white such that the minute cutout patterns 34A extend parallel with each other.

It should be noted that such minute cutout patterns 34A extending parallel with each other induce localized modulation of driving electric field applied to the liquid crystal layer 31 in the activated state of the liquid crystal display apparatus 30, and as a result, the liquid crystal molecules in the liquid crystal layer 31 are tilted in the extending direction of the cutout patterns 34A in the activated state of the liquid crystal display apparatus 30.

In the pixel electrode 34, it will be noted that the direction of tilting of the liquid crystal molecules is restricted symmetrically with regard to the center of the pixel electrode in correspondence to the regions A-D disposed symmetrically about the center of the pixel electrode, and thus, the viewing angle characteristics of the liquid crystal display apparatus 30 is improved remarkably.

With such an MVA liquid crystal display apparatus 30, it is advantageous, for the purpose of improvement of response speed of the liquid crystal display device, that the liquid crystal molecules contacting with the orientation films 35 and 37 are aligned with a pre-tilt toward the direction in which the liquid crystal molecules are to be tilted in the activated state with regard to the direction exactly perpendicular to the substrates 31A and 31B in the non-activated state of the liquid crystal display apparatus 30.

In relation to this, there is a proposal of PSA (polymer-sustained alignment) technology shown in FIGS. 5A-5C.

Referring to FIG. 5A, the liquid crystal layer 31 contains liquid crystal molecules 31L and further a photocurable resin composition 31 in the form of monomers or oligomers.

In the non-activated state of FIG. 5A, the liquid crystal molecules 31L are aligned in a direction substantially perpendicular to the substrates 31A and 31B as a result of the action of the orientation films 35 and 37, while in the PSA technology, the liquid crystal molecules are tilted in a desired direction by applying a driving voltage between the electrodes 34 and 36 in the step of FIG. 5B.

In the PSA technology, a ultraviolet radiation is applied further to the liquid crystal layer 31 in the tilted state of the liquid crystal molecules and polymerization is induced in the photocurable resin compound. With this, there is formed a polymer network in the liquid crystal layer 31.

By forming a polymer network in the liquid crystal layer 31 as such, the liquid crystal molecules 31L are tilted slightly in the desired direction to form a pre-tilt as a result of the action of the polymer network, even after application of the drive voltage is eliminated as shown in FIG. 5C.

Generally, a liquid crystal display apparatus is formed by: assembling a pair of mutually opposing glass substrates via a seal member; evacuating the gap between the substrates to a vacuum state; and injecting a liquid crystal into the gap.

On the other hand, there is a new technology of assembling a liquid crystal panel in these days, in which a seal member is formed along a periphery of a glass substrate in the form of a frame and a liquid crystal is dripped into a region of the glass substrate defined by the seal member with a predetermined amount. Thereafter, an opposing glass substrate is. attached to the foregoing glass substrate via the frame member in a vacuum environment and assembling of the liquid crystal panel is completed.

By using such a technology, it is possible to inject the liquid crystal quickly and uniformly, even in the case there are formed large projecting structures such as the alignment control structure 36A shown in FIG. 3A on the opposing substrate 31B with large number.

In the liquid crystal display apparatus that uses the PSA technology, on the other hand, the liquid crystal used for the injection contains photocurable resin compounds (monomers or oligomers) as explained before, and because of this, there arises a problem, when such monomers or oligomers have caused reaction during the injection process of the liquid crystal, of precipitation of polymers in the liquid crystal before the photopolymerization process of FIG. 5C. Such premature polymerization leads to formation of defects such as bright spots in the display of the liquid crystal display apparatus. Further, in the case there is caused partial polymerization in the monomers or oligomers during the dripping process of the liquid crystal, there tends to occur non-uniform polymer concentration in the liquid crystal layer 31, while such non-uniform polymer concentration leads to irregularity of display.

In a first aspect of the present invention, there is provided a method of fabricating a liquid crystal display apparatus having a liquid crystal layer sandwiched between a first substrate and a second substrate, comprising the steps of:

forming said liquid crystal layer by dripping a liquid crystal composition containing a photopolymerizable component upon said first substrate; and

sandwiching said liquid crystal layer between said first and second substrates by mounting said second substrate upon said first substrate,

wherein said dripping step of said liquid crystal composition is conducted in a state in which said liquid crystal composition is shielded from a radiation of a wavelength that causes polymerization in said photopolymerizable component.

According to the present invention, exposure of the liquid crystal composition containing a photocurable resin compound to light is prevented during the dripping process of the liquid crystal composition in the fabrication process of a liquid crystal display apparatus that achieves control of alignment of the liquid crystal molecules in the liquid crystal layer by using the PSA technology. Thereby, occurrence of defects such as bright spots or uneven display originating from unintended exposure is effectively suppressed.

Other objects and further features of the present invention will become apparent from the following detailed description when read in conjunction with the attached drawings.

### BRIEF DESCRIPTION OF THE DRAWINGS

FIGS. 1A and 1B are diagrams explaining the principle of an MVA liquid crystal display apparatus;

FIG. 2 is a diagram showing the construction of an MVA liquid crystal display apparatus according to a related art of the present invention;

FIGS. 3A and 3B are diagrams showing the construction of the MVA liquid crystal display apparatus of FIG. 2;

FIG. 4 is a diagram showing an example of a pixel electrode used with the liquid crystal display apparatus of FIG. 2;

FIGS. 5A-5C are diagrams showing the fabrication process of a liquid crystal display apparatus according to a related art of the present invention;

FIG. 6 is a flowchart showing the fabrication process of a liquid crystal display apparatus according to a first embodiment of the present invention;

FIG. 7 is a diagram showing the dripping process of liquid crystal in the process of FIG. 6;

FIG. 8 is a diagram showing the panel assembling process in the process of FIG. 6;

FIG. 9 is a diagram showing a second embodiment of the present invention; and

FIG. 10 is a diagram showing a third embodiment of the present invention.

### DETAILED DESCRIPTION OF THE PREFERRED EMBODIMENTS

### First Embodiment

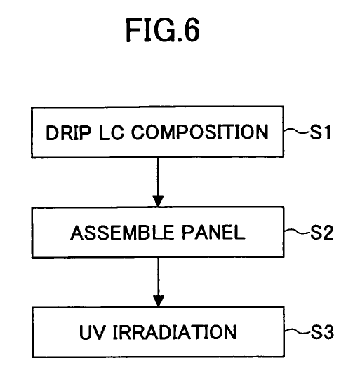

FIG. 6 is a flowchart showing a part of the fabrication process of a liquid crystal display apparatus according to a first embodiment of the present invention.

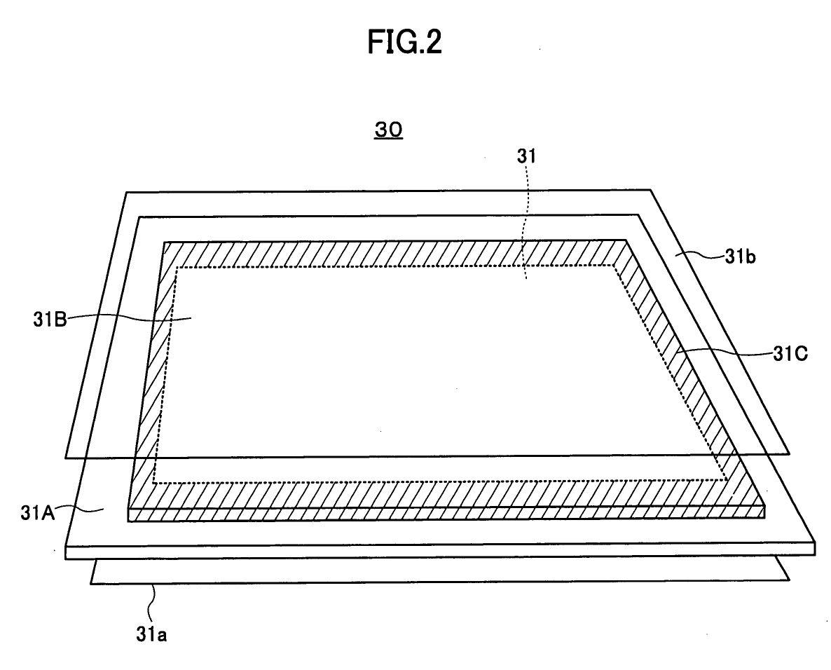

Hereinafter, the flowchart of FIG. 6 will be explained for the example of FIG. 2 showing the fabrication process of the liquid crystal display apparatus 30, wherein those parts corresponding to the parts described previously are designated by the same reference numerals and the description thereof will be omitted.

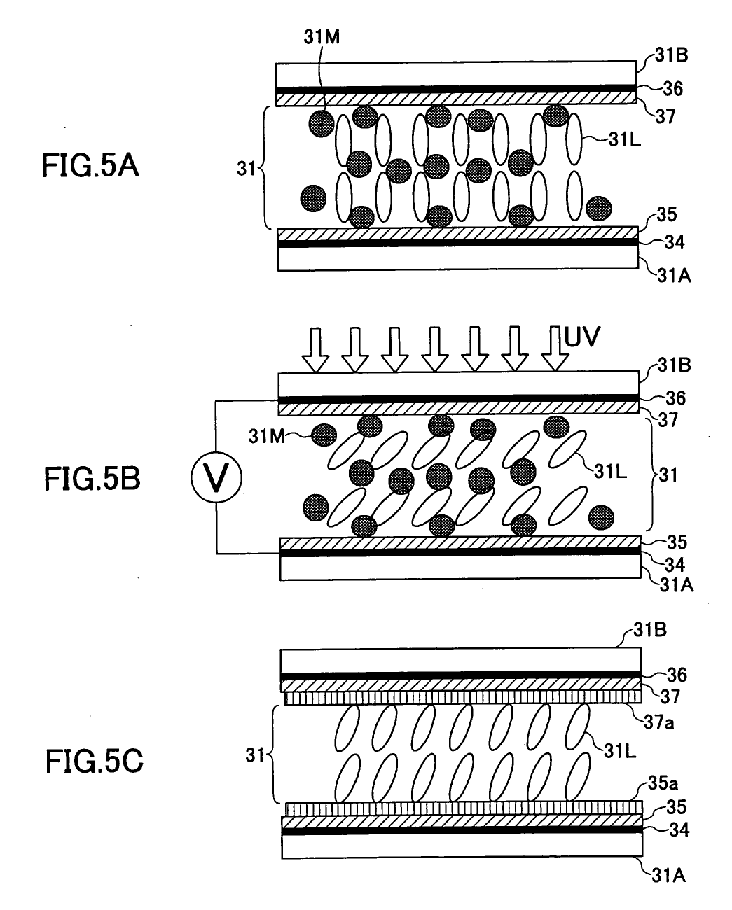

Referring to FIG. 6, the fabrication process of the liquid crystal display apparatus of the present embodiment comprises: a step 1 of dripping a liquid crystal composition upon the glass substrate 31A; a step 2 of mounting and bonding the opposing glass substrate 31B upon the glass substrate 31A conducted in a vacuum environment to assemble a liquid crystal panel; and a step 3 of irradiating ultraviolet irradiation explained already with reference to FIGS. 5A-5C.

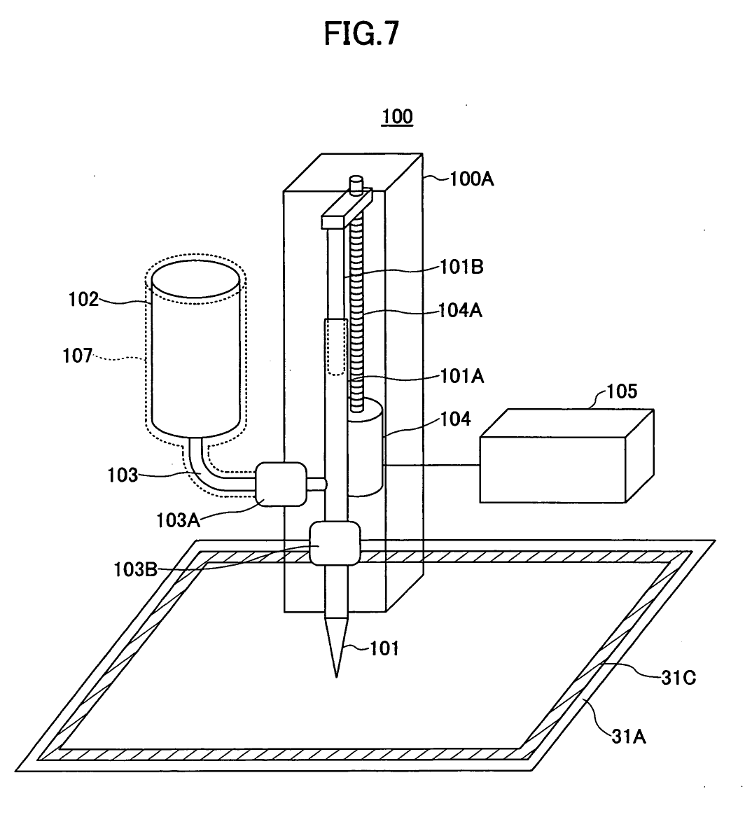

FIG. 7 shows the outline of the step 1 of dripping the liquid crystal composition upon the glass substrate 31A.

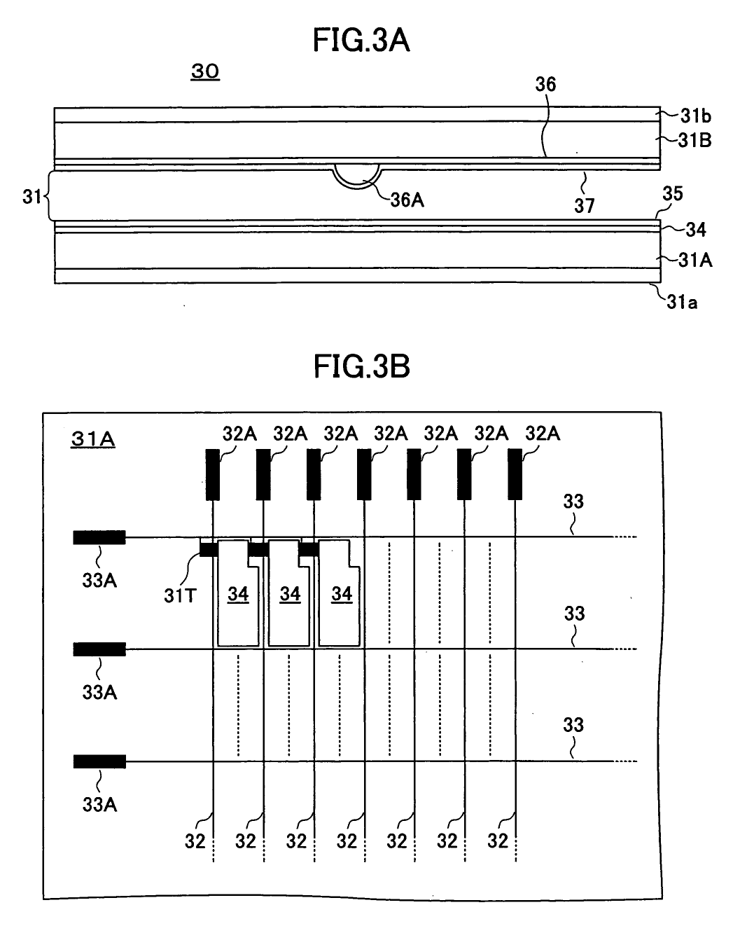

Referring to FIG. 7, the liquid crystal composition is dripped to a region of the glass substrate 31A defined by the seal member 31C from a dispenser 100, wherein the present embodiment uses a liquid crystal composition having a negative dielectric anisotropy and added with an acrylic monomer for the photopolymerizable component with the proportion of 0.3 wt % in anticipation of use of the PSA technology. Here, it should be noted that the glass substrate 31A is a TFT substrate formed with the TFTs 31T as explained with reference to FIGS. 3A and 3B. Thus, the glass substrate 31A carries thereon the pixel electrodes 34 and the orientation film 35 already.

The dispenser 100 includes, in a dispenser body 100A of a metal, or the like, a dripping nozzle 101, a syringe 101A continuing to the dripping nozzle 101, a plunger 101B cooperating with the syringe 101A, and the like, wherein the liquid crystal in a liquid crystal tank 102 is supplied to the syringe 101A via a tube 103 and valves 103A and 103B. Here, the valve 103A controls the communication between the tube 103 and the syringe 101A while the valve 103B controls the communication between the syringe 101A and the nozzle 101.

The dispenser 101 is further provided with a screw rod 104A driven by a motor 104, wherein the screw rod 104A is coupled mechanically to the plunger 101B and drives the plunger 101B in response to the rotation of the motor 104. Further, the construction of FIG. 7 includes a controller 105 for driving the motor 104.

Thus, the liquid crystal in the tank 102 is introduced into the syringe 101A by pulling the plunger 101B by the motor 104 while closing the valve 103B and opening the valve 103A, and the liquid crystal composition in the syringe is dripped to the region of the glass substrate 310B surrounded by the seal member 31C via the dripping nozzle 101 as the plunger 101B is lowered in the state that the valve 103A is closed and the valve 103B is opened.

Here, it should be noted that the liquid crystal tank 102 and the tube 103 are formed conventionally of a transparent plastic, while in the present embodiment in which the liquid crystal composition contains a photopolymerizable component, the apparatus of FIG. 7 covers the liquid crystal tank 102 and the tube 103 continuously by an aluminum foil 107 so as to suppress photopolymerization inside the tank or tube.

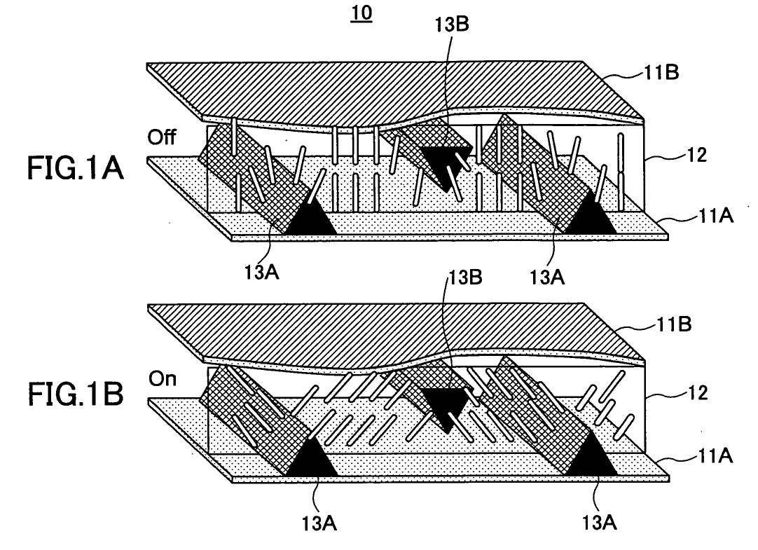

By using such a dripping apparatus, the problem that the photopolymerizable component added to the liquid crystal composition causes photopolymerization even partially when the liquid crystal composition is dripped upon the glass substrate 31A in the step S1 of FIG. 1, is effectively eliminated.

Next, in the step 2 of FIG. 6, the opposing glass substrate 31B is disposed upon the glass substrate 31A and is jointed to the seal member 31C on the glass substrate 31A.

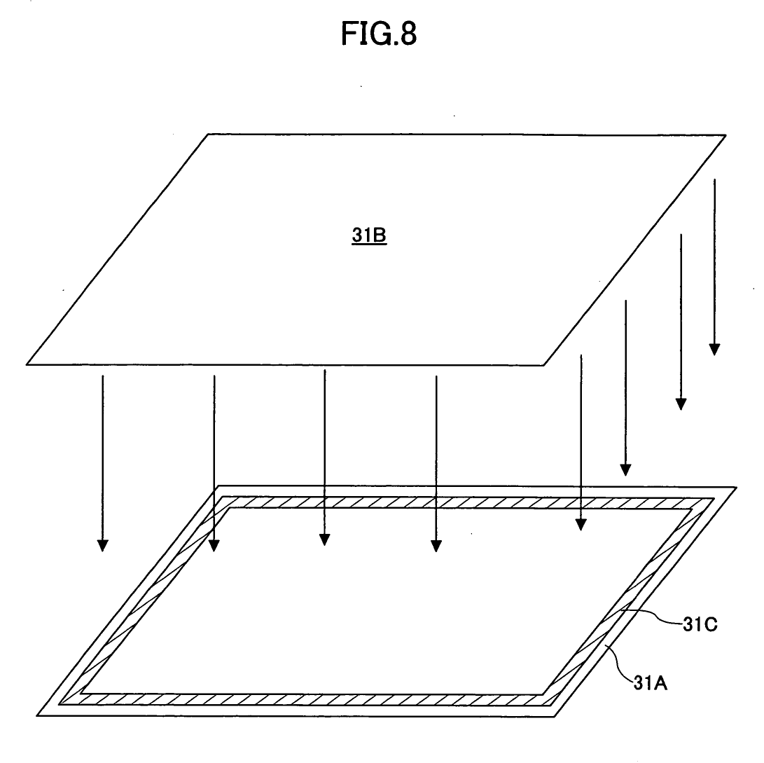

With this, the liquid crystal panel is obtained such that the liquid crystal layer 31 is confined between the glass substrate 31A and the glass substrate 31B. It should be noted that the glass substrate 31B is formed with the opposing electrode 36, the alignment film 37 and further the alignment control structure 36A. The jointing step of FIG. 8 is conducted in a vacuum environment so as to avoid formation of bubbles in the liquid crystal layer 31.

Further, with the step 3 of FIG. 6, a drive voltage is applied between the opposing electrode 36 and the pixel electrodes 34 and irradiation of ultraviolet radiation is conducted to the liquid crystal layer 31 in this state similarly to the step of FIG. 5B. With this, it becomes possible to induce a desired pre-tilt in the liquid crystal molecules.

According to such a procedure, it becomes possible to obtain a liquid crystal display apparatus capable of providing high-quality display free from optical defects such as bright spots.

In the dispenser of FIG. e7, it is also possible to use a shading tape for covering the liquid crystal tank 102 and the tube 103.

### Second Embodiment

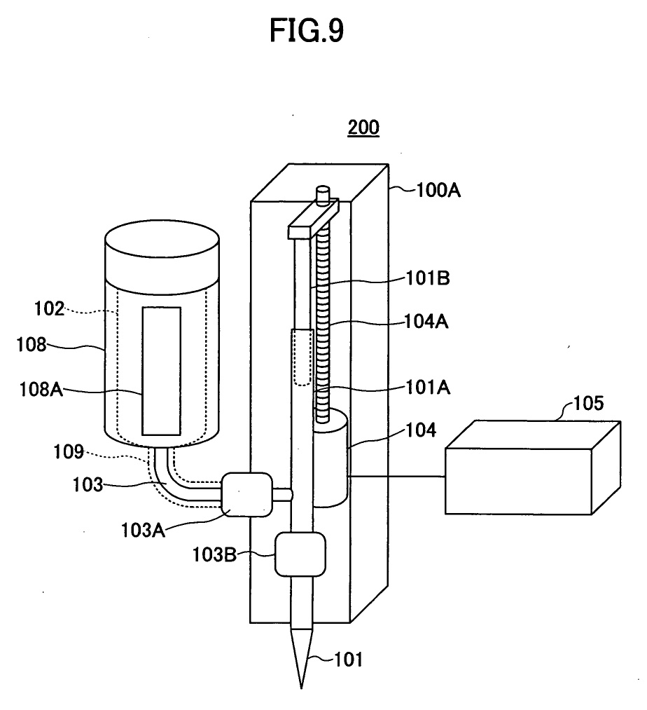

FIG. 9 shows the construction of a dispenser 200 according to a second embodiment of the present invention, wherein those parts corresponding to the parts are designated by the same reference numerals and the description thereof will be omitted.

Referring to FIG. 9, the liquid crystal tank 102 is accommodated into a holder 2 of a metal such as aluminum, and the tube 103 is covered by a shading cover 109 such as aluminum foil or tape. With this, exposure of the liquid crystal composition in the liquid crystal tank 102 or in the tube to the light is avoided before the liquid crystal composition is dripped upon the glass substrate 31A.

Further, with the embodiment of FIG. 9, there is formed a window 108A in the aluminum holder 108, wherein the window 108A is closed by an acrylic resin plate that cuts out the ultraviolet radiation component of the wavelength of 400 nm or less.

According to such a construction, it becomes possible to read the amount of the liquid crystal remaining in the liquid crystal tank 102, by observing the liquid level. Thereby, it becomes possible to increase the productivity of a production line.

### Third Embodiment

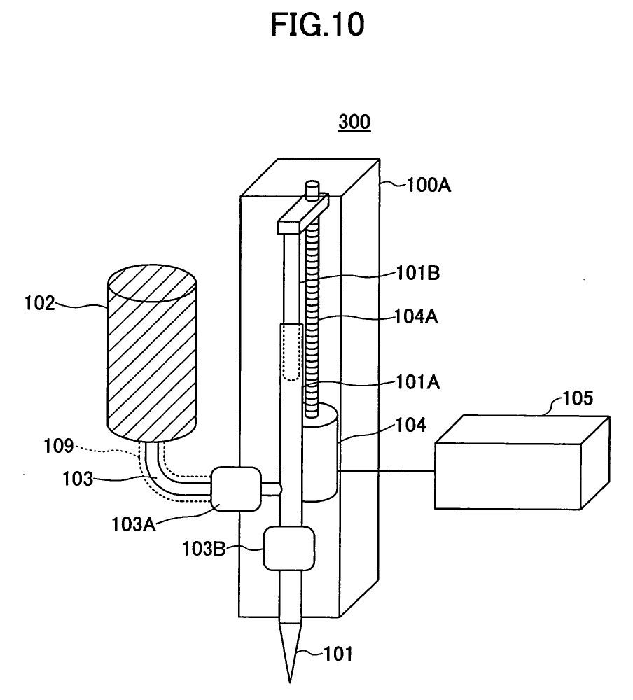

FIG. 10 shows the construction of a dispenser 300 according to a third embodiment of the present invention, wherein those parts corresponding to the parts described previously are designated by the same reference numerals and the description thereof will be omitted.

Referring to FIG. 10, the present embodiment uses a semi-transparent glass bottle of brown color for the liquid crystal tank 102. Such a brown glass bottle cuts the ultraviolet component of the wavelength of 400 nm or less, and thus, there occurs no exposure in the liquid crystal composition held therein.

Further, the tube 103 is covered by the shading cover 109 such as aluminum foil or tape, and thus, there occurs-no exposure in the liquid crystal composition in the liquid crystal tank 102 or in the tube 103 in advance to the dripping upon the glass substrate 31A.

The construction of FIG. 10 allows visual observation of the liquid crystal composition remaining in the tank 102 and is thus advantageous for improving the productivity when used in the production line of liquid crystal display apparatus.

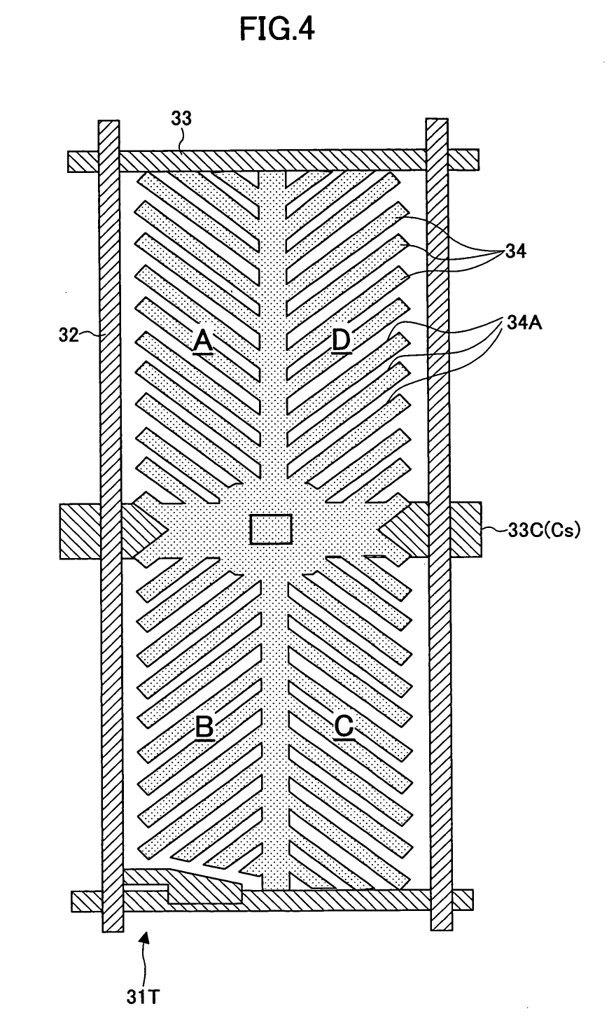

While the present invention has been explained heretofore for the example of fabricating a liquid crystal display apparatus that uses the alignment control structure 36A of liquid crystal shown in FIG. 3A and the multi-domain pixel electrode 34 shown in FIG. 4, the present invention can be used extensively to the production of liquid crystal display apparatuss that uses the PSA technology explained with reference to FIGS. 5A-5C.

In the present invention, it should be noted that the dripping of the liquid crystal composition by using the device 100 may be conducted also upon the glass substrate 31B, in place of the glass substrate 31A.

Further, the proportion of the photopolymerizable component in the liquid crystal composition is not limited to 0.3 wt %, but may be changed from 0.01 wt % to 1.0 wt %.

Further, the photopolymerizable component is not limited to the acrylic monomer, but compounds such as epoxy acrylic monomer or liquid crystal monomer may also be used.

Further, the present invention is not limited to the embodiments described heretofore, but various variations and modifications may be made without departing from the scope of the invention.

The present invention is based on Japanese patent application 2005-157584 filed on May 30, 2005, the entire contents of which are incorporated herein as reference.

What is claimed is:

1. A method of fabricating a liquid crystal display apparatus having a liquid crystal layer sandwiched between a first substrate and a second substrate, comprising the steps of:
forming said liquid crystal layer by dripping a liquid crystal composition containing a photopolymerizable component upon said first substrate; and
sandwiching said liquid crystal layer between said first and second substrates by mounting said second substrate upon said first substrate,
wherein said dripping step of said liquid crystal composition is conducted in a state in which said liquid crystal composition is shielded from a radiation of a wavelength that causes polymerization in said photopolymerizable component.

2. The method as claimed in claim 1, wherein said step of dripping said liquid crystal composition is conducted in the state that said liquid crystal composition is shielded from a radiation having a wavelength of 400 nm or shorter.

3. The method as claimed in claim 1, wherein said step of dripping said liquid crystal composition is conducted by a dripping apparatus comprising a liquid crystal tank holding said liquid crystal composition, a tube supplying said liquid crystal composition from said liquid crystal tank, and a dispenser dripping said liquid crystal composition supplied from said tube, at least said liquid crystal tank and said tube being shaded optically.

4. The liquid crystal display apparatus as claimed in claim 3, wherein said liquid crystal tank and said tube are covered by a shading member.

5. The method as claimed in claim 2, wherein said step of dripping said liquid crystal composition is conducted by a dripping apparatus comprising a liquid crystal tank holding said liquid crystal composition, a tube supplying said liquid crystal composition from said liquid crystal tank, and a dispenser dripping said liquid crystal composition supplied from said tube, wherein said liquid crystal tank is formed of a material cutting an optical component of a wavelength of 400 nm or shorter.

6. The method as claimed in claim 1, wherein said liquid crystal display apparatus is a vertically aligned liquid crystal display apparatus carrying a projecting structure on said first substrate.

7. The method as claimed in claim 6, wherein said liquid crystal display apparatus carries plural pixel electrodes on said second substrate, each of said pixel electrodes being divided into plural domains.
